(19) United States
(12) Patent Application Publication
(10) Pub. No.: US 2023/0415600 A1
(43) Pub. Date: Dec. 28, 2023

(54) Solutions for building a low-cost electric vehicle charging infrastructure

(71) Applicant: Microgrid Labs Inc, Durham, NC (US)

(72) Inventors: NARAYANAN SANKAR, Durham, NC (US); SHARABH SHUKLA, Durham, NC (US); NAMIT SINGH, Durham, NC (US)

(73) Assignee: Microgrid Labs Inc, Durham, NC (US)

(21) Appl. No.: 18/036,254

(22) PCT Filed: Nov. 13, 2021
(86) PCT No.: PCT/US21/59282

§ 371 Date: May 10, 2023

Related U.S. Application Data
(60) Provisional application No. 63/113,395, filed on Nov. 13, 2020.

(51) Int. Cl. B60L 53/62; B60L 53/63; B60L 53/66

(52) U.S. Cl. CPC B60L 53/62; B60L 53/66; B60L 53/63

(57) ABSTRACT

A method to scale EV charging infrastructure incrementally at low cost using a novel distributed control system. Distributed Control system comprises of a distributed network of nodal controllers and power flow sensors minoring the hierarchal architecture of electrical power distribution network of facilities and city utilities The control system optimizes the electric power flow in the electrical circuits of the charging network given the constraints imposed by the addition of EV chargers in the electrical power distribution network and by the varying activity of EV chargers in the structure.

### CROSS REFERENCE TO RELATED APPLICATIONS

This application the benefit of U.S. Provisional Patent Application 63/113,395 filed on Nov. 13, 2020 and is incorporated by reference herein in entirety.

### FIELD OF INVENTION

The invention pertains generally to addressing the adverse impact on electrical distribution network caused by the variable nature of EV charging load. More specifically, the invention relates to Distributed Control System using edge computing devices physically located near the electrical circuits feeding power to EV chargers. The device includes multilevel optimization algorithms which perform dynamic optimization of power level across multiple EV chargers connected to one or more electrical circuit and redistribution of power flow. The invention possesses numerous benefits and advantages over known and existing devices, approaches, and systems. In particular, the invention utilizes distributed optimization algorithms at multiple levels mirroring the hierarchical architecture of the electrical power distribution network in facilities and in utilities.

### BACKGROUND OF THE INVENTION

Electric Vehicles (EVs) are likely to comprise 30% of all vehicles globally by 2030. As EV numbers surge, so must EV chargers. Given long commute distances, driving habits, time taken to charge using home-based chargers, and range anxiety, there is a need for chargers at locations like workplace, hotels, shopping malls, parking garages, etc. besides home charging. Most of these facilities already exists complete with electrical power distribution network. These existing electrical power distribution networks do not consider the peculiar nature of EV charging load like high load factor, high coincidence factor and its non-stationary nature. As a result, installing large number of EV charger in these facilities is a challenge and will overload the existing electrical power distribution network. There will be similar challenges at utility grid as well since the grid infrastructure has not been designed to support this peculiar nature of EV charging.

Challenge 1—Overloading of existing electrical power distribution network.

Electrical power distribution network refer FIG. 19 in most facilities and in utilities are not designed to support the high demands caused by the simultaneous charging of several EVs. As EV penetration increases there will be overloading of the electrical distribution network both at the facility and at the grid level. This overloading can cause overload protection devices like circuit breakers to disconnect the charging load. Though this will protect the circuit this will interrupt the operation. Hence there is a need for an intelligent load management solution that keeps the load below the circuit capacity.

Current solution: Charging station management systems try to mitigate this issue by managing the aggregate EV charging load at the facility. However, they will need to be upgraded when chargers are installed. Also, these charging management systems do not consider the impact of onsite energy generation and storage—Refer FIG. 20.

Challenge 2—Uneven distribution of EV charging across multiple electrical circuit will cause overload in one or more electrical circuits even when there is no overloading at the aggregate level.

As most of the facilities are already built, they already have existing electrical power distribution systems. These are designed for stationary loads with certain assumption like load factor of around 0.8 and coincidence factor of around 0.7. EV charging loads on the other hand can have higher load factors and coincidence factor due to its non-stationary nature as it can move between electrical circuits Refer FIG. 1. Non-stationary nature of the EVs can cause the charging load to move between electrical circuits This can aggravate this problem by dynamically changing the load factor and coincidence factors in different circuits. This can result in overloading of multiple electrical circuits even when the aggregate load is within limits—Refer FIG. 2. Though circuit breakers and other overload protection devices can protect the circuit by disconnecting the EV charging load, it will result in interruption of the operation. This requires an intelligent load management solution that optimizes the charging load according to certain priorities and redistribute the load across multiple circuits. Refer FIGS. 3, 4 & 5.

Current solution: Charging station management systems try to mitigate this issue by managing the aggregate EV charging load at the facility. However, managing EV charging load at the aggregate level does not automatically guarantee that individual electrical circuits are not overloaded since these circuits are not designed to support simultaneous charging of all EVs connected to them. Incorporating the electrical distribution network hierarchy in the current cloud-based charging station management system is complex and will require significant engineering every time new EV chargers are installed. As a result, commonly available charging station Management Systems do not consider the hierarchy of electrical power distribution network in their control algorithms—Refer FIGS. 19 and 20.

Challenge 3—Potential overloading of pole mounted transformers and utility grid infrastructure feeding residential circuits

Many houses with EVs have started installing level 2 chargers of capacity between 2 kW and 10 kW at homes. Unlike heaters/air-conditioning/washers/dryers/electric irons loads, these EV charging loads will most likely happen simultaneously across multiple households at night. This challenge is not felt today as EV penetration is very low. As EV penetration increases more and more homes will install these EV chargers and their simultaneous operation will overload the utility transformers/network feeding these homes. In the US for example, residential loads are supplied by pole mounted transformers and/or ground mounted transformer. Typically, about 5 to 10 houses are supplied by a pole mounted transformer and/or ground mounted transformer. These transformers will get overloaded when many of these homes start installing level 2 chargers and charge their EVs at night. This overload will not be limited to the pole mounted transformer alone. This will also be felt by the other electrical circuits and transformers upstream—Refer FIG. 6.

Current solution: Utilities have not started implementing any solutions yet as the problem has not become apparent. Once this does, they will have to start stagger/schedule the operation of chargers to limit/minimize simultaneous charging. Like the Challenge 2 described earlier in commercial facilities like workplaces, hotel etc. this problem will not be limited to pole mounted transformers and will start appearing in upstream circuits as well. Hence utilities will need a multi-level control system that mirrors the utility network hierarchy, optimizes the load at every node and redistribute the load across multiple circuits

Challenge 4—Reliability of communication systems

Most charging Station Management System available in market reside in the cloud and communicate with EV chargers over the internet via the Wi Fi or via cellular network. Since EV chargers at most of the facilities are installed in basements, covered spaces or out in the field, this communication link is often flaky and unreliable.

Current solution: Some suppliers mitigate this issue by installing an onsite controller. This adds a layer of complexity as these onsite controllers need to be upgraded when new chargers are added. Communication could be a challenge even with the onsite controller unless the communication medium is hard wired—Refer FIG. 20.

Challenge 5—Scalability of the solution

As EV penetration increases, facilities will expand their EV charging infrastructure by installing more EV chargers. Since this will happen over time, it means starting with few EV chargers and adding more units in incremental steps. This needs a control system that can be easily scaled over time.

Today's solutions require continuous upgrade the Cloud-based charging station management system. This is however costly and time consuming.

To address the challenges listed earlier, there is a market need for a control system that:
can prevent overloading in the power distribution network both at the aggregate level as well as at individual electrical circuit.
can be easily scaled with minimum engineering efforts
needs minimum data exchange with external systems

A potential solution is a distributed control system that:
performs most of the computation physically near to EV chargers thus minimizing the need for data exchange can mirror the hierarchical architecture of the electrical power distribution network
is modular and scalable
would meet such a market need.

Smart EV charging—EV charging optimization through central systems.

U.S. Pat. No. 9,026,347 to Gadh proposes a smart charging infrastructure for managing demand and enabling EV charging without overloading the infrastructure. This control system with elaborate communication infrastructure and the associated equipment makes the installation complex and expensive. Cost of such systems can only be justified if a facility is installing hundreds of EV chargers in one go. Unfortunately, this is not the case as facilities are installing only a few chargers now and plan to expanding them over time based on demand. For this they need a system that is cheap to start with and can be scaled over time. Moreover, central control systems often function at an aggregate level without considering how the charging load is distributed across the electrical network. This solution doesn't capture the hierarchical electrical power distribution network.

Patent publication US20120013299A1 to Prosser for a modular EV charging controller that defers the installation of electrical upgrades, this solution doesn't capture the hierarchical electrical power distribution network.

The commercially product available from Mobility House is focused on fleet charging where the infrastructure is already designed as per need for charging of electric vehicles and managing the maximum power demand at aggregate level using currently available cloud-based charging station management system. This solution doesn't capture the hierarchical electrical power distribution network.

The commercial available EV Charge Controller from Schneider defers the upgrade the installation of electrical upgrades and managing the maximum power demand at aggregate level using currently available cloud-based charging station management system. This solution doesn't leverage the hierarchical electrical power distribution network.

The commercial available EV Charge Controller from Bender defers the upgrade the installation of electrical upgrades and managing the maximum power demand at aggregate level. This solution doesn't leverage the hierarchical electrical power distribution network either.

The commercial available solution from Evconnect is managing the maximum power demand at aggregate level using currently available cloud-based charging station management system. This solution doesn't capture the hierarchical electrical power distribution network either.

The commercial available from Greenlots defers the upgrade the installation of electrical upgrades and managing the maximum power demand at aggregate level using currently available cloud-based charging station management system. This solution doesn't capture the hierarchical electrical power distribution network.

An article published by objectbox explaining the benefits of using edge computing office in EV charging context for better EV user experience for interaction and payment methods. Currently, most of EV Charges communicates with cloud-based charging station management system for all services like slot booking, account subscription, payments etc via website or mobile phone. Because of the installation site of these EV chargers makes communication link with cloud-based charging station management system flaky and sometime not available. This solution doesn't capture the hierarchical electrical power distribution network.

### BRIEF DESCRIPTION OF INVENTION

Novel distributed control system based on edge computing devices installed physically near to electrical circuits supplying power to EV chargers complete with low band width communication network and control algorithms for optimizing and scheduling EV charging loads. The distributed control system has a multi-level architecture mirroring the hierarchical architecture of the electrical power distribution network—Refer FIG. 7. It comprises several circuit level controller units directly controlling multiple EV chargers, intermediate level controllers controlling multiple circuit level controllers, a plant level controller controlling multiple intermediate level controllers and optionally a cloud-based charging station management system.

Control functions are distributed across these controller units at multiple levels mirroring the existing electrical power distribution network of the facility. This prevents any overloading in the electrical power distribution network both at the aggregate level as well as at individual electrical circuits. The control system design allows each controller unit to function independently controlling the EV charging loads or controller units feeding lower-level sub-distribution boards while receiving certain additional set points (e.g., upper/lower bounds) from the higher-level controller.

Cloud-based charging station management system is complete with smartphone application having user interfaces for facility manager and for EV driver that oversees the operation and provides management functionalities like user authentication, billing and many other standard functions and for EV drivers trying to use the EV chargers.

Edge computing device significantly reduces the computational complexity and data handling in each controller allowing the use of low-cost hardware with less computing power and low band width communication.

Innovative features of the system include:
Distributed control system based on edge computing device mirroring the hierarchical architecture of existing electrical power distribution network.
Software control algorithms based on mathematical optimization and/or rule-based logic and/or simulation.
Plug and play design: Ability to add edge computing devices to the electrical network with minimum engineering efforts.
Auto discovery: Ability to automatically discover new EV chargers connected to the circuit and includes them in the control logic.
Modular and scalable architecture.

The instant solution is novel from the current industrial approaches to building EV charging infrastructure. There is an overall market need to lower infrastructure cost, improve communication latency and provide the flexibility for expansion or contraction of the infrastructure. It is expected to be disruptive and alter the charging infrastructure landscape.

The proposed solution is a distributed control system architecture with edge computing device mirroring the existing electrical power distribution network. In this architecture final control is performed at the electrical circuits supplying power to EV chargers while honouring the load limits set by the electrical circuits upstream. Distribution of controls across several edge computing devices reduces computational complexity enabling the use of low-cost hardware with less computing power and low bandwidth communication.

Rationale for adopting this approach is given below:

Need for mirroring electrical power distribution network hierarchy refer FIG. 19:

Electrical power distribution network follows a hierarchical architecture with multiple levels of distribution. Most electrical loads like lighting, air conditioning, industrial machineries are stationary in nature in the sense they remain connected to designated electrical circuits. While designing the original circuits, designers made certain assumptions like load factor of <0.8 and coincidence factor of <0.7 or 0.8 at respective electrical circuits and panel-boards Refer FIGS. 1 & 3. Monitoring and controlling of maximum power demand from these loads is easy and can be done at aggregate level without risk of overloading downstream circuits. However, EV charging loads are having high load factor are non-stationary in nature. They can also move from one circuit to another as EV drivers are free to connect their EVs to any chargers. This could increase the load factor and coincidence factor of one circuit to 1.0 and reduce it on another, to say at 0.3 Refer FIG. 2. Under these circumstances limiting the total EV charging load at the facility level (aggregate load) will not automatically guarantee that individual circuits are not overloaded.
Limitations with currently available cloud-based charging station management system: Architecture of electrical power distribution networks can be quite complex in large facilities. This makes it difficult to include the constraints imposed by this architecture in the control algorithms of charging station management systems. Distributed control systems with an architecture that can mirror the architecture of the electrical power distribution network can solve these limitations.
Communication challenges: current cloud-based charging station management systems need fast and reliable communication since data processing is centralized and control signals must be distributed in real time. Fast and reliable communication could be a challenge as EV chargers in many of these facilities are located in basements, covered spaces and/or out in the field which makes this communication often flaky and unreliable. Edge computing device helps overcome these challenges by performing the controls locally with minimum data exchange with other devices.
Scalability Challenge: Transition to EVs has just started and will happen over time.

This will result in addition of new EV chargers every few months/years. This will need a modular control system that can start with a few EV chargers and grows over time. Distributed control system based on edge computing device is ideal for this.

### BRIEF DESCRIPTION OF DRAWINGS

FIG. 1—Shows the facilities design considering the load factor and available power level across electrical circuits.

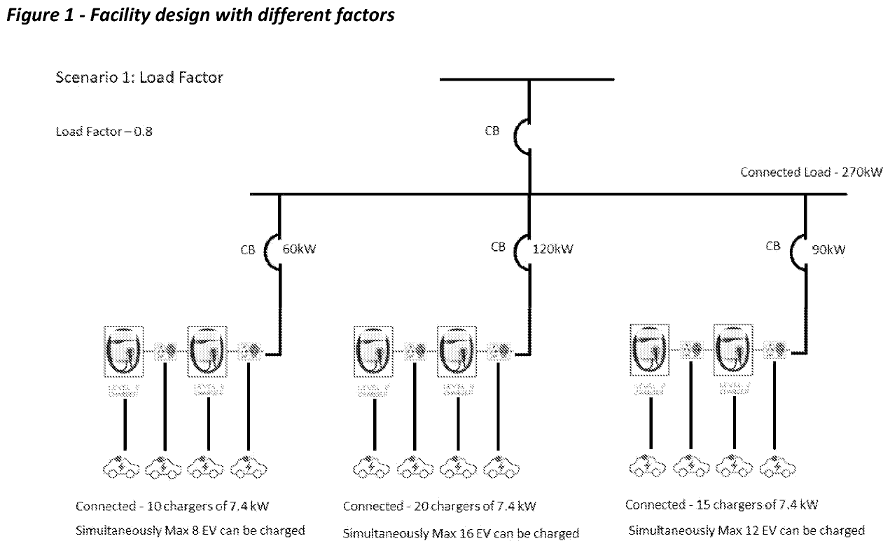

FIG. 2—Shows overloading of electrical circuit as load is above circuit breaker overload protection due to non-stationary nature of EV charging load.

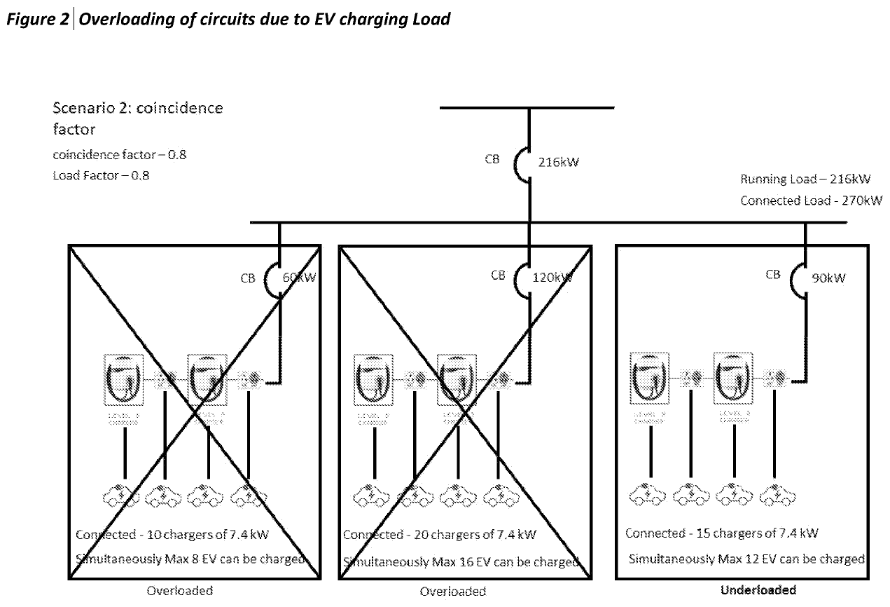

FIG. 3—Shows re-distribution of load using intelligent load management system using local controller physical at electrical circuit level.

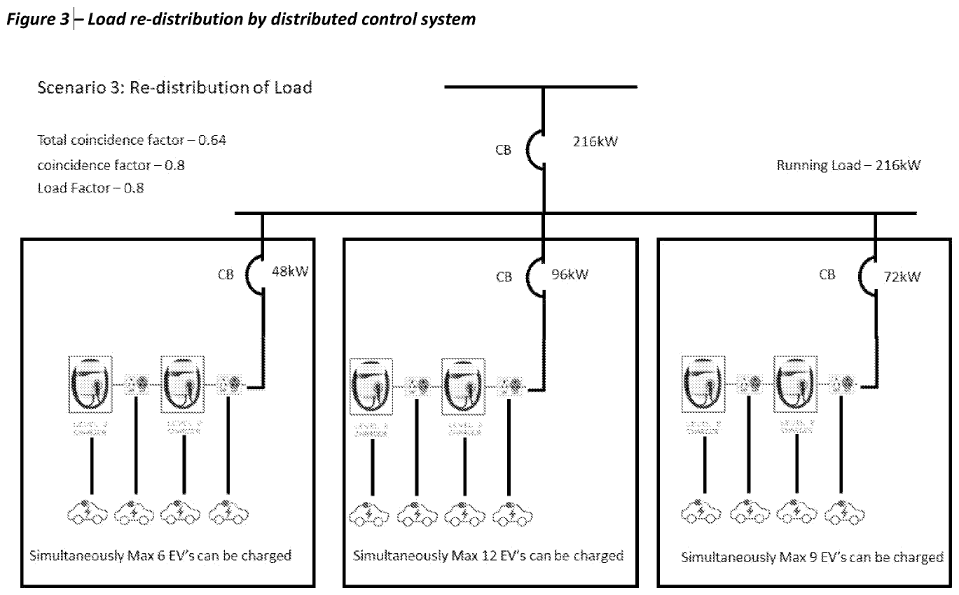

FIG. 4—Shows re-distribution of load due to non-stationary nature of EV charging load.

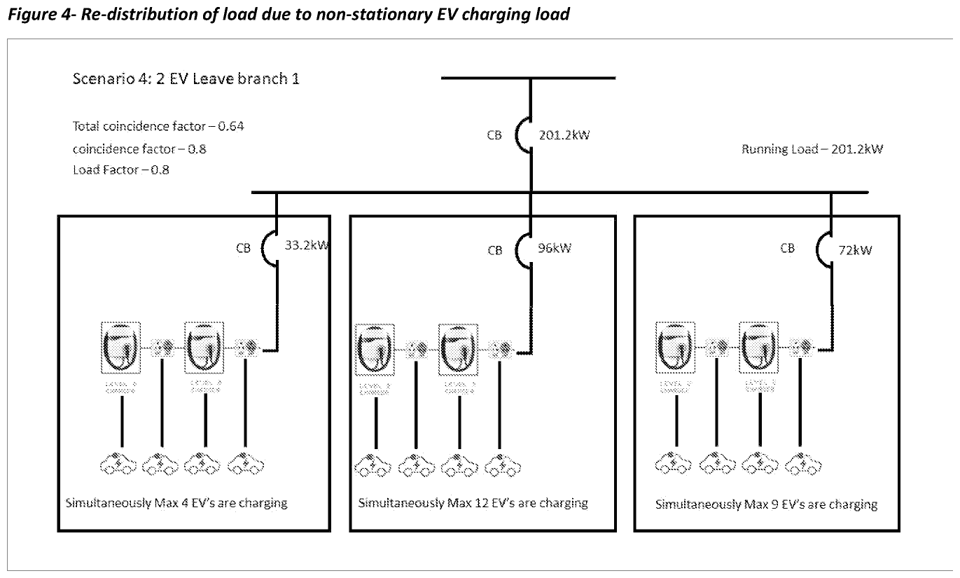

FIG. 5—Shows re-distribution of load due to non-stationary nature of EV charging load.

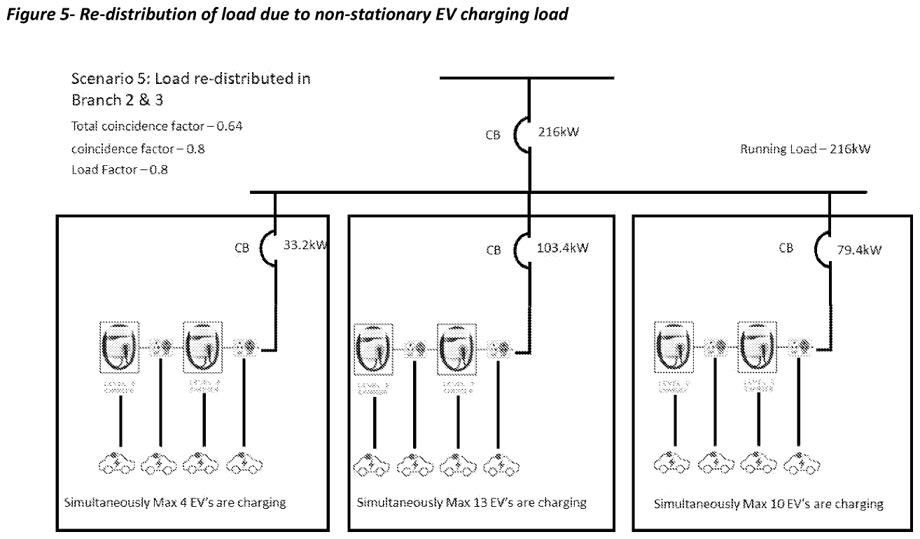

FIG. 6—Hierarchal electrical power distribution network in residential sector.

FIG. 7—Shows novel multi-level distribution control system with CLC/ILC/PLC.

FIG. 8—Shows data flow architecture plant, intermediate and circuit level controller.

FIG. 9—Shows the functionalities and components of novel distributed control system.

FIG. 10—Shows the data exchange between circuit level controller and EV chargers.

FIG. 11—Shows the data exchange between intermediate level controller and circuit level controller.

FIG. 12—Shows the data exchange between plant level controller and intermediate level controller.

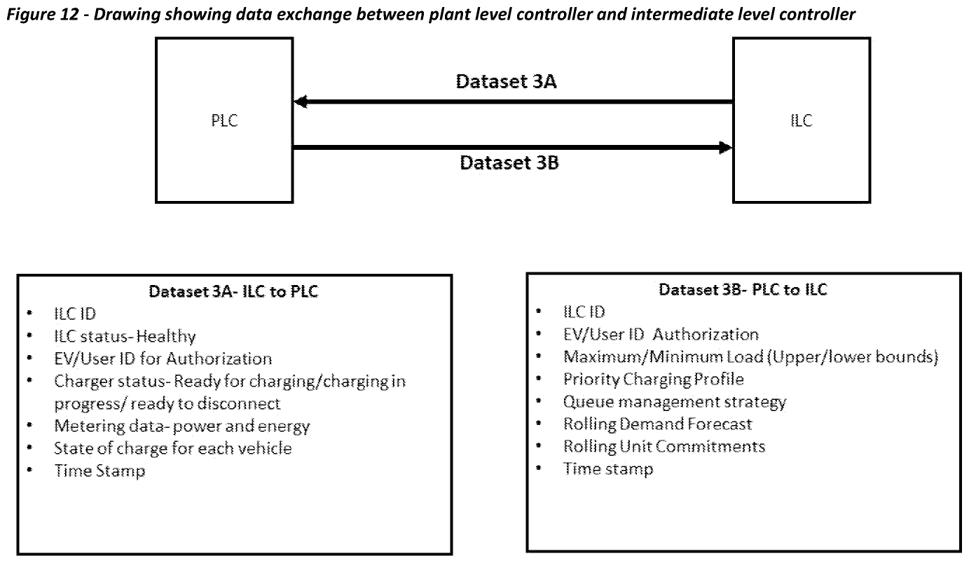

FIG. 13—Shows the data exchange between plant level controller and distributed energy resources (DER's)

FIG. 14—Shows data exchange between cloud-based charging station management system and plant level controller.

FIG. 15—Shows data exchange between stand-alone circuit controller and cloud-based charging station management system

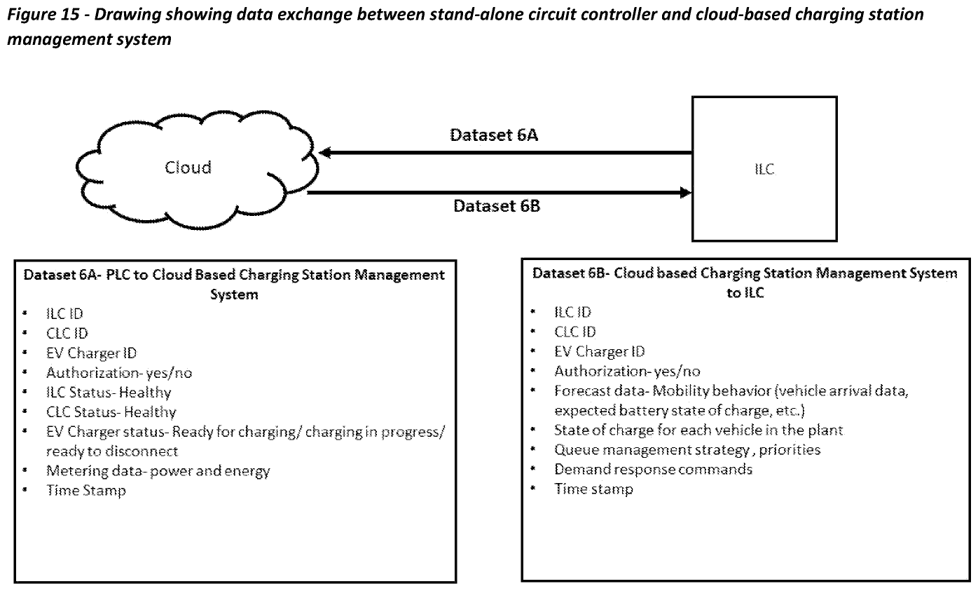

FIG. 16—Shows data stand-alone architecture of intermediate circuit level controller with cloud-based charging station management system

FIG. 17—Shows communication protocols and methods of novel distributed control system

FIG. 18—Shows the user interaction with EV chargers in distributed control system architecture

FIG. 19—Shows the hierarchal architecture of electrical power distribution network in facilities.

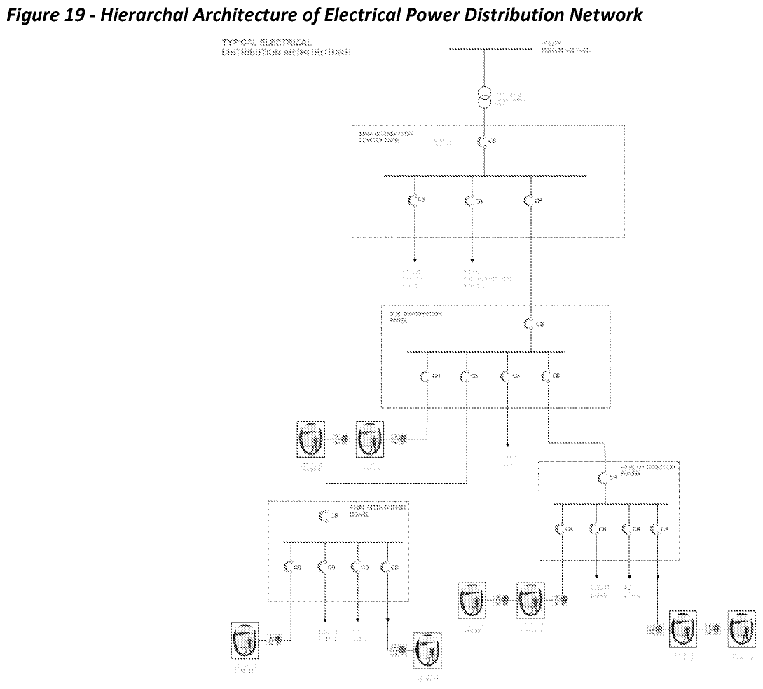

FIG. 20—Shows the current available solution managing the EV charging load at aggregate level with onsite controller and cloud-based management system.

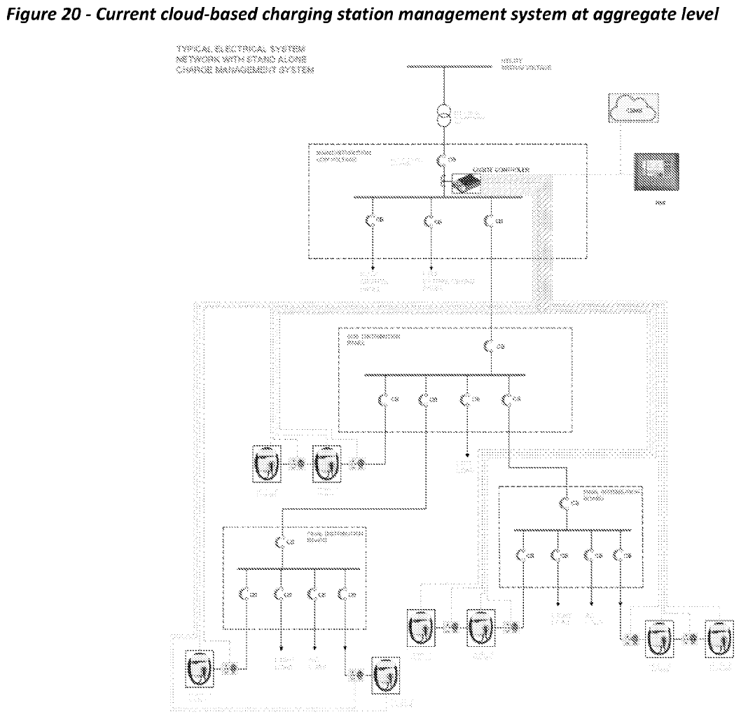

### DETAILED DESCRIPTION OF THE INVENTION

Our solution covers a distributed control system for dynamically managing the EV charging load in these facilities. The control system architecture mirrors the hierarchical architecture of the existing electrical power distribution network.

System Overview

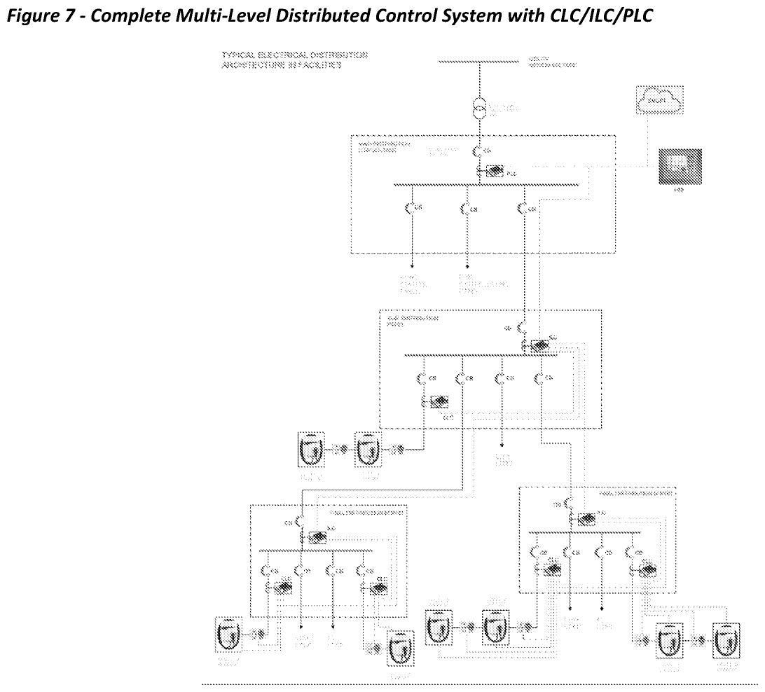

FIGS. 7 & 8 illustrates the overall architecture of the solution. The solution comprises:

Part 1A—edge computing devices installed on one or more electrical circuits which will feed EV chargers in existing electrical power distribution network. These devices perform key control functions like optimization, scheduling and demand management locally and physically near the different electrical circuits.

Part 1B—Cloud-based charging station management system complete with smartphone application having user interfaces for facility manager and for EV drivers that oversees the operation and provides management functionalities like user authentication, billing and many others standard functions and for EV drivers trying to use the EV chargers.

Part 1C—Communication system interconnecting EV chargers, the different elements of distributed control system and cloud-based charging station management system.

The distributed control system uses state of the art advances in mathematical modelling, optimization, data sciences and control engineering. The system software intelligently recommends a custom EV charging schedule based on charging needs and behaviour of the consumers in each scenario, whether it be home, campus, commercial facility, commercial buildings, residential buildings, public facilities (e.g., shopping malls, parking garages, public EV charging facilities, roadside charging, gas stations) and so forth. The novel solution further uses the mathematical models, machine learning, and convex optimization to determine the optimal control set-points. This is accomplished by the system utilizing proprietary methods (algorithms) that optimally schedules their operation during the day in combination with other facility electrical loads, distributed generation/energy storage (DER). The distributed control system generates ON/OFF commands and/or power level set points for the EV chargers and optionally DERs across multiple circuits in existing electrical power distribution network.

System Architecture

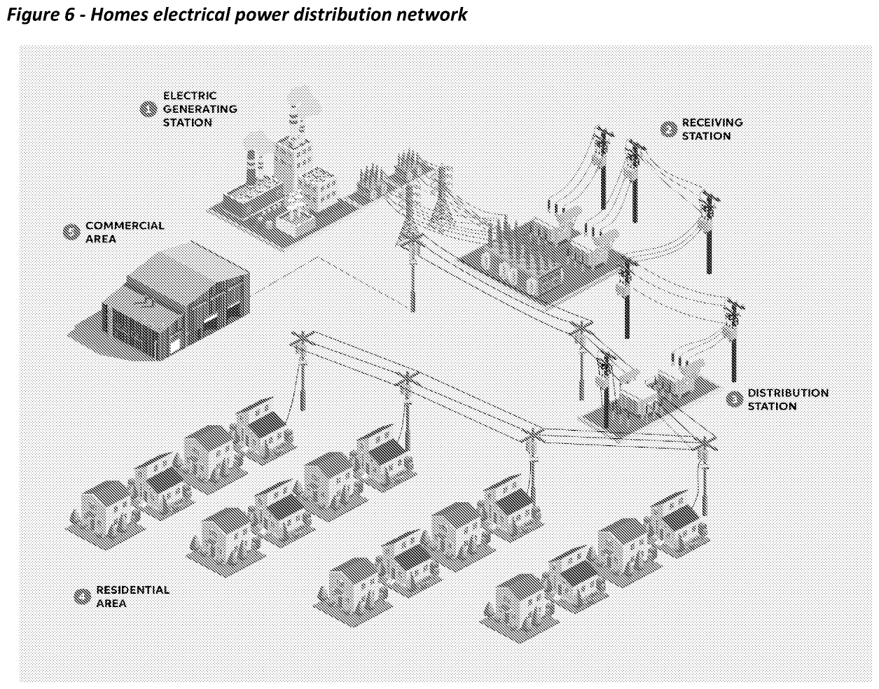

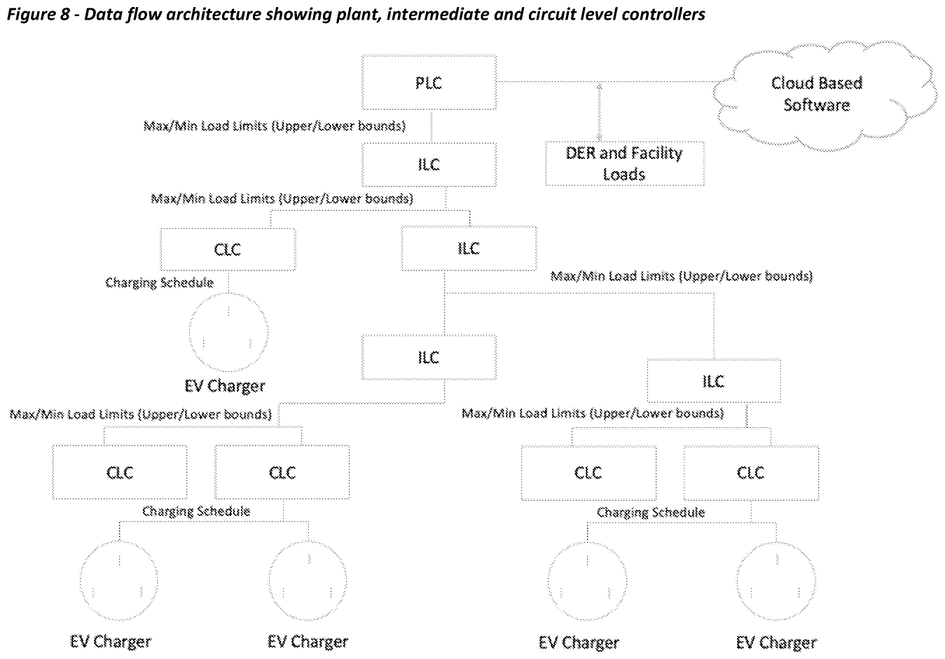

To make the distributed control system modular and scalable, it follows a distributed architecture that mirrors the hierarchy of the existing electrical power distribution network architecture. This is achieved by performing key control functions like optimization, scheduling and demand management locally at each electrical circuit and all the way to the point of interconnection to utility and beyond—Refer FIGS. 6 & 7. Even though key control functions are performed locally, each controller unit also receives additional set points (e.g., max/min load limits i.e. upper and lower bounds) from the higher-level controller unit that is immediately upstream. Control functions and data of each edge computing device are limited to the devices connected to it—Refer FIG. 8. These edge computing devices can be installed near each node on the electrical network.

The distributed control system based on edge computing device can be expanded as more EV chargers are added in these facilities. For example, a parking garage can manage their EV chargers by installing these controller units on the electrical circuits of the electrical power distribution network where EV chargers are connected. Additional controller units can be installed in other electrical circuits of the electrical power distribution network as the system expands. This is altogether a different approach than having a conventional cloud-based charging station management system to manage the aggregate demand at the facility level and controlling EV charging loads directly.

System Components

Distributed Control System

The distributed control system is divided into three layers—circuit level layer, one or more intermediate level layers and a plant level layer.

Circuit Level Controller (CLC)

Functional description: Circuit Level Controller (CLC) is the bottom most layer of the distributed control system. Circuit level Controllers (CLC) are installed at the outgoing feeders of electrical distribution boards where the EV chargers are connected.

The CLCs generate rolling unit commitment (chargers to be committed) and optimal dispatch (charging schedule) based on individual charging needs, behaviour of the consumers, customer priority, cost of charging and queue management strategies. The target is to minimize charging costs while meeting user demand and preventing any overloading at the associated electrical circuit. The schedule is then converted to ON/OFF commands and/or charging rate power set points.

CLCs receive demand forecast, unit commitment data and upper/lower bounds (max/min load limit) from the intermediate level controller installed in the upstream electrical circuit—Refer FIGS. 8 & 10. This is required to ensure that there is no overloading at the immediate upstream circuit when all the downstream circuits are fully loaded either from EV charging loads or other existing on-site loads. The system scales by adding CLCs to electrical circuit in panel boards that control EV chargers connected in electrical circuits.

CLCs exchange data with EV chargers and with Intermediate Level Controller located immediately upstream CLC hardware: CLC is typical based on Raspberry Pi or Arduino microcontrollers.

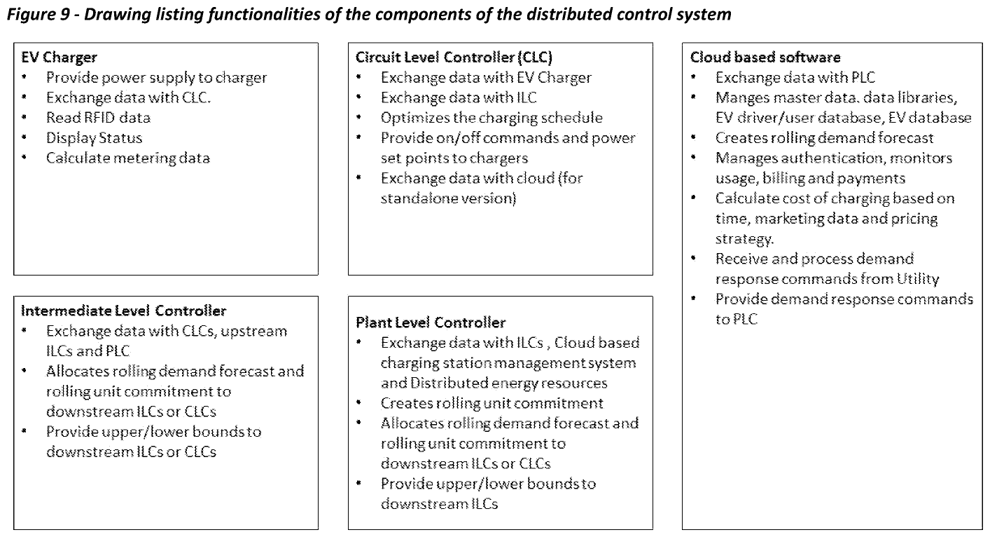

FIGS. 9,10,11,12,13 and 14 explains the functionality, inputs, and outputs.

Intermediate Level Controller (ILC)

Intermediate level controller (ILC) sits between the Plant level controller (PLC) and the circuit level controller (CLC). Intermediate level Controllers (ILC) are installed at the incomer of electrical circuit/sub distribution board that provide power to panel boards or sub distribution boards.

ILCs optimize the operation at the sub-distribution panels (intermediate level) and provides demand forecast, rolling unit commitment and max/min load limits based on aggregate charging needs, priority, cost of charging and queue management strategies. The target is to minimize charging costs while meeting user demand and preventing any overloading of the associated electrical circuit. This data is passed on to CLCs downstream.

Setting of upper/lower bounds (max/min load limits) for the CLCs ensure that there is no overloading at the intermediate level when all the downstream circuits are fully loaded due to EV charging load.

Like CLCs, ILCs also receive upper/lower bounds (max/min load limit) from the intermediate level controller or plant level controller installed on the immediate higher-level circuit—Refer FIGS. 8 & 11. This is required to ensure that there is no overloading at the immediate upstream circuit when all the downstream circuits are fully loaded due to EV charging load.

ILCs will exchange data with ILCs/CLCs installed on circuits immediately downstream and ILCs/Plant level Controller installed on circuits immediately upstream.

ILCs are optional and are required only if there are upper-level distribution circuits. This scenario may happen when EV penetration really grows. The system scales by adding ILCs to intermediate feeders as more and more electrical circuits start supporting non-stationary EV charging loads.

Large systems may have multiple levels of intermediate level controllers. This depends on the architecture of the existing electrical power distribution network in facilities and in city utilities.

ILC Hardware: ILC is typical based on Raspberry Pi/Arduino/embedded microcontrollers.

FIGS. 9,10,11,12,13 and 14 explains the functionality, inputs, and outputs.

Plant Level Controller (PLC)

The plant level controller sits between the cloud-based charging station management system and the intermediate level controller. Plant level Controllers (PLC) are installed at the incoming feeder of main distribution board in facilities.

PLCs optimize the operation at the plant level and provides demand forecast, rolling unit commitment and max/min load limits based on aggregate charging needs, priority, cost of charging and queue management strategies. The target is to minimize charging costs while meeting user demand and preventing any overloading of the associated electrical circuit. This data is passed on to ILCs downstream. As PLCs are at the plant level it may control the use of distributed energy resources (DERs—onsite generation and energy storage systems) in the optimization logic and generate set points to distributed energy resources like solar PV and battery energy storage

PLCs exchange data with ILCs and with cloud-based charging station management system. PLCs will also exchange data with DERs. Refer drawings for functionality, inputs, and outputs—Refer FIGS. 8,9,10,11,12,13 and 14.

PLCs are also optional and are required only if there is a need to optimize power allocation to different sections of the plant considering non-stationary EV charging load connected in multiple electrical circuits across the facility and any energy generation and/or storage assets. This scenario may happen when EV penetration really grows and the impact is felt at the plant level.

PLC Hardware: PLC is typically based on embedded microcontroller or workstation.

Optional—Standalone Version of Circuit Level Controller

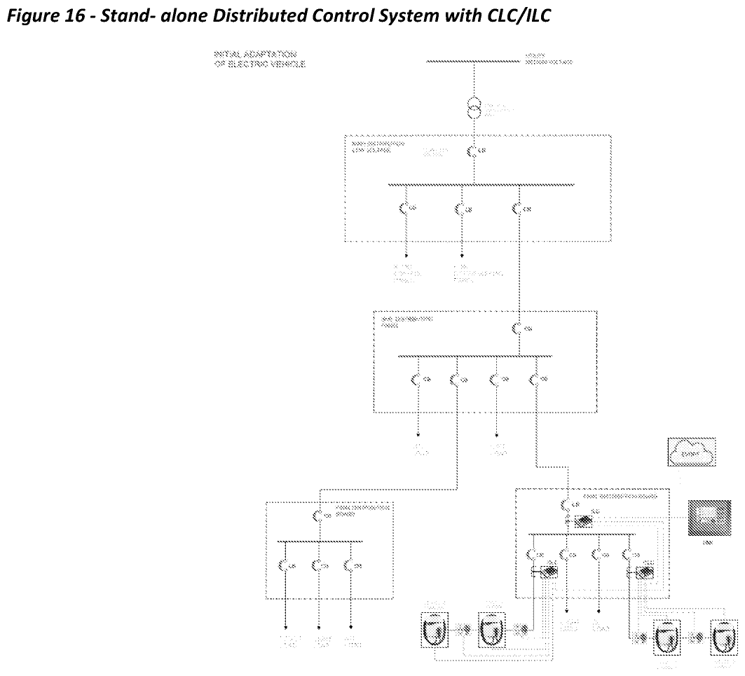

At current levels of EV penetration most facilities will have only a few EV chargers. Since this will not create any overloading of the upstream circuits, they may only require ILCs and CLCs at this point in time—Refer FIG. 16. However, there is still a need for exchanging data with the cloud-based charging station management system. This will be achieved by creating a version of ILC that will also have a communication gateway with the cloud-connectivity. This communication will be via cellular network or via Wi Fi or via power line carrier communication to the local internet router at the plant. Refer FIGS. 9,15 and 16 for functionality, inputs, and outputs.

Software and Algorithms

The control algorithms of the solution are distributed across multiple layers namely Circuit Level Controller, Intermediate Level Controller, Plant Level Controller and optionally the cloud-based Charging management system. These different controllers accomplish different levels of control but by exchanging critical information amongst them, they can bring controllability to the whole system.

Key functionalities of the Distributed Control System include:

Rolling Forecast of Charging Demand:

Demand forecasting algorithm forecasts charging demand for the entire facility for the next several hours on a rolling basis. For example, charging demand is forecast for the next 24 hours on an hourly basis and the forecast is updated every hour. Demand forecasting algorithm forecasts mobility behaviour (e.g., EV Arrival time/departure time, SoC upon arrival or a statistical distribution of SoC upon arrival, SoC upon departure, required SOC upon departure or a statistical distribution of SoC upon arrival, customer identification, customer preferences and market prices for EV charging). Demand forecasting is performed by the plant level controller or optionally by the cloud-based charging management system. Demand forecasting can be based on linear regression or some form of machine learning.

Rolling Unit Commitment

Rolling unit commitment commits/reserves the chargers required for the next several hours say 6 or 12 hours. Rolling unit commitment algorithm uses data from demand forecasting and static parameters to generate charging unit commitment on a rolling basis say every hour. The rolling unit commitment is updated frequently, say every hour, based on the most recent results from demand forecasting. This continuous update of the rolling unit commitment model helps manage the large variability and stochasticity in EV charging demand. The rolling unit commitment model at the PLC could be a linear/non-linear programming models whereas at the ILC and CLC level it could be based on rule-based logic running every hour with 6 or 12 or 24 hours as the time horizon. Mixed Integer models and runs every hour with 6 or 12 or 24 hours as the time horizon. The optimization problem is configured to have an optimization function also called the objective function. The objective function can be a weighted sum of operational costs, revenues from charging and the end user satisfaction. The weights for these objective functions could be adjusted by the user. The user also has the option of choosing another objective function—e.g., revenues from providing charging service. Objective functions are defined in the cloud-based charging station management system or in the PLC which then flows down to ILCs and CLCs. In another embodiment of the Controller design the rolling unit commitment model at ILCs and CLCs can be a Mixed Integer model running every hour with 6 or 12 or 24 hours as the time horizon.

Rolling unit commitment is performed at all levels—PLC, ILC and CLC. At the PLC level this provides unit commitment data on an hourly basis in the form of aggregate load data. This is then allocated amongst different ILCs based on aggregate charging needs, aggregated customer priority, aggregated cost of charging and aggregated impact of queue management strategies.

Rolling unit commitment at the ILC level provides unit commitment data on a 30 min or hourly basis in the form of aggregate load data. This is then allocated across different CLCs based on aggregate charging needs, aggregated customer priority, aggregated cost of charging and aggregated impact of queue management strategies.

Rolling unit commitment at the CLC level provides unit commitment data on a 30 min or hourly basis in the form of ON/OFF schedule for the EV chargers controlled by the CLC.

Optimal Dispatch

Optimal dispatch provides ON/OFF schedule and/or power set points to the EV chargers every 15 minutes. The optimal dispatch algorithm uses actual data from EV chargers and vehicle telematics data to generate optimal dispatch data on a rolling basis say every 5 or 15 minutes. The optimal dispatch is updated every hour based on the most recent EV/charging data. This continuous update of the optimal dispatch model helps manage the large variability and stochasticity in EV arrivals/departures/charging demand.

Optimal dispatch is performed only at the CLCs based on a linear/non-linear/Mixed Integer programming/rule-based model. The objective function can be a weighted sum of operational costs, revenues from charging and end user satisfaction. The weights for these objective functions could be adjusted by the user. The user also has the option of choosing another objective function—e.g., revenues from providing charging service. Objective functions are defined in the cloud-based charging station management system or in the PLC which then flows down to ILCs and CLCs.

Algorithms for the Circuit Level Controller (CLC)

Key functionalities of the CLC are rolling demand forecast, rolling unit commitment and optimal dispatch.

Rolling Demand Forecast:

In a preferred embodiment, CLCs convert the aggregate forecast charging demand data received from upstream ILC in the form of aggregated load data to individual EV Charging forecast. This algorithm at CLC creates EV charging forecast for optimization horizon, for example the next 2 hours. The main aim of this forecast is to improve the workings of the optimal dispatch algorithm. Since the optimal dispatch algorithm uses real time data, the system forecasts charging demand data for the optimization horizon to improve the result.

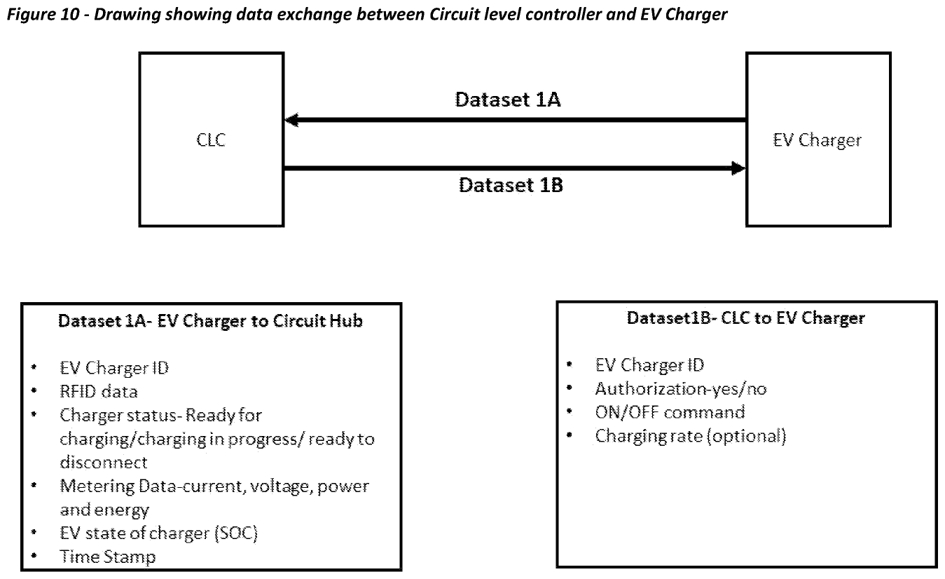

Demand forecast conversion algorithm creates short term forecasts of EV charging load demand and EV data (e.g., EV Arrival time/departure time, SoC upon arrival or a statistical distribution of SoC upon arrival, SoC upon departure, required SOC upon departure or a statistical distribution of SoC upon arrival, customer identification, customer preferences and market prices for EV charging.
Inputs/Outputs—Refer FIG. 10.
Technique/Logic—Rule-based logic.

In another embodiment, CLCs receive demand forecast directly from the cloud-based charging management system or PLCs and generates demand forecast of mobility data while taking care of the constraint imposed by the ILC upstream—Refer FIGS. 7 & 8.

Rolling Unit Commitment

Rolling unit commitment at the CLC converts the aggregated rolling unit commitment from ILCs and reserves the EV chargers required for the next 6 or 12 hours. This data can be used for assigning EV chargers to EVs upon arrival. It provides hourly ON/OFF schedule for the EV chargers controlled by the CLC. The rolling unit commitment is updated every hour based on the most recent results from rolling demand forecast. This continuous update of the rolling unit commitment model helps manage the large variability and stochasticity in EV charging demand.
Inputs/Outputs—Refer FIG. 10.
Technique/Logic—rule-based logic.

In another embodiment, CLCs use charging demand data received from PLC/cloud-based charging management system and applies mathematical optimization techniques (linear/non-linear/mixed integer programming) to generate rolling unit commitment.

Optimal Dispatch

In a preferred embodiment, the optimal controller algorithm optimizes the charging process of individual vehicles data through a model predictive controller running say every 5 or 15 minutes. Optimal dispatch at the CLC provides on/off commands and/or power level set points to EV chargers. The optimal dispatch model runs every 15 minutes with 1 or 2 hours as the optimization time horizon. It uses combination of real-time and forecast data and constraints coming from the upstream ILC to generate an optimum charging schedule based on EV driver preferences such as:
Charge as soon as Possible (ASAP)—This implies that EV chargers start charging as soon as an EV is connected. Here the target will be to get all EVs achieve same average or minimum battery state of charge.
Grid optimized—Depending on the Time of use (TOU) tariffs, EV user will get the most cost-effective charging, though no commitments on the SOC of the battery are made. Charging in this mode depends on the total available demand and the price preferences of the EV user. As in the above case, the target will be to get all EV users to achieve same average battery state of charge.
Customer specific—Here the EV user can set a preferred range of the charging price and a preferred target end State of Charge (SOC). The system then looks to get the preferred SOC for each user with the least cost of charging.
Inputs/Outputs—Refer FIG. 10.
Technique/Logic—Mixed integer linear programming/linear programming/non-linear programming

Objective function: weighted sum of operational costs, revenues from charging and the end user satisfaction.

In another embodiment the CLCs use rule-based logic or simulations to perform optimal dispatch

Algorithms for the Intermediate Level Controller (ILC)

Key functionalities of the ILC are rolling demand forecast and rolling unit commitment.

Rolling Demand Forecast:

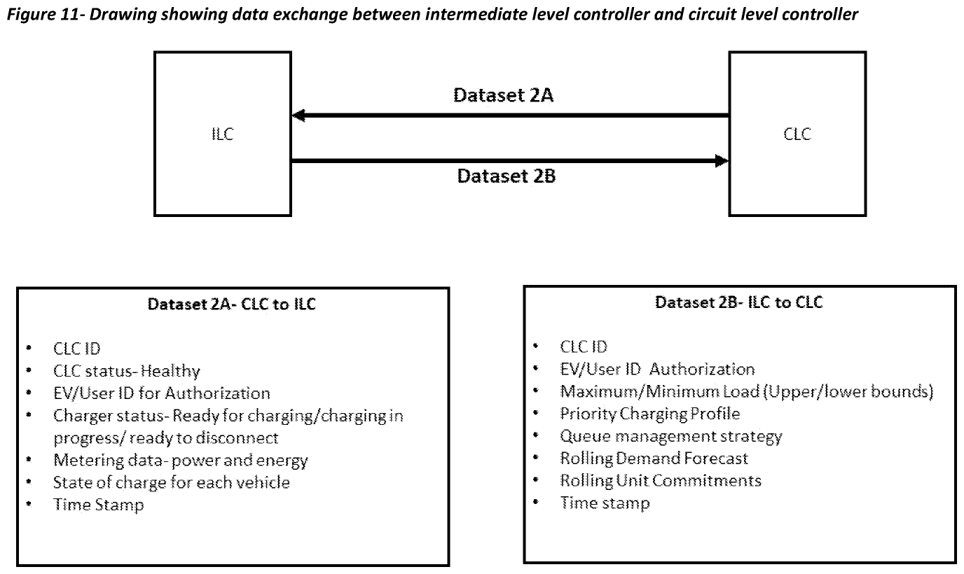

In a preferred embodiment, ILCs convert the demand forecast data received from upstream PLC to upper bounds (max load limits) to ILCs/CLCs.
Inputs/Outputs—Refer FIG. 11
Technique/Logic—Rule-based logic.

Rolling Unit Commitment

Rolling unit commitment at the ILC converts the aggregated rolling unit commitment from the PLC and sets the upper bounds for the ILCs downstream for a time horizon of 6 or 12 hours. The rolling unit commitment is updated every hour based on the most recent results from rolling demand forecast. This continuous update of the rolling unit commitment model helps manage the large variability and stochasticity in EV charging demand.
Inputs/Outputs—Refer FIG. 11.
Technique/Logic—rule-based logic.

In another embodiment, ILCs use charging demand data received from PLC/cloud-based charging station management system and applies mathematical optimization techniques (linear/non-linear/mixed integer programming) to generate rolling unit commitment—Refer FIGS. 7 & 8.

Algorithms for the Plant Level Controller (PLC)

Key functionalities of the PLC are rolling demand forecast and rolling unit commitment.

Rolling Demand Forecast:

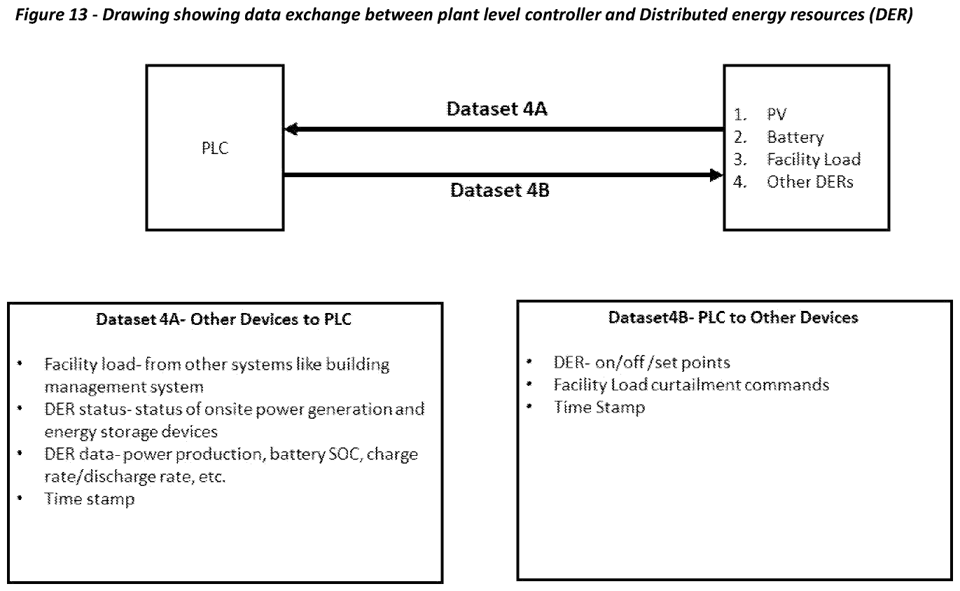

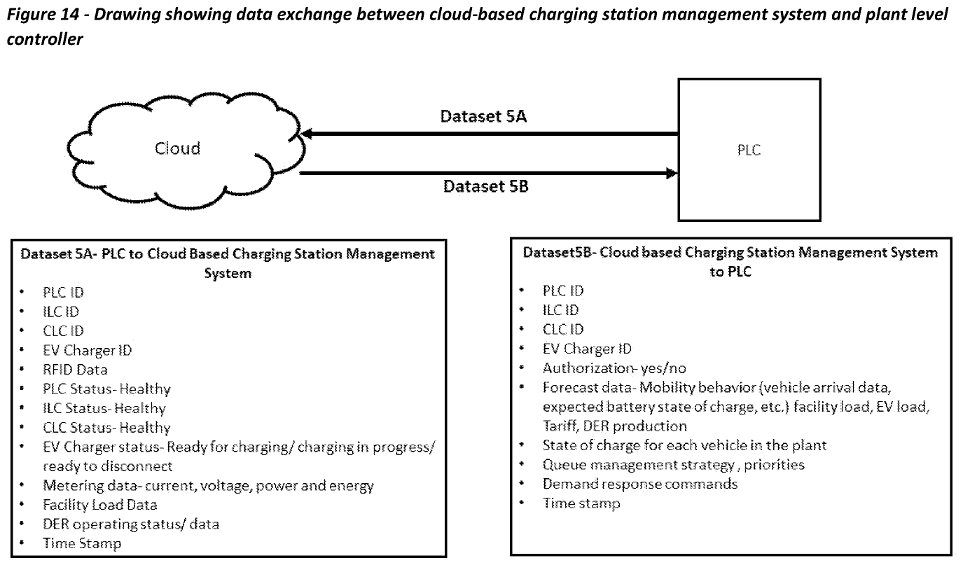

In a preferred embodiment, PLCs convert the demand forecast data received from upstream cloud-based charging station management system to upper bounds (max load limits) to ILCs and/or CLCs.
Inputs/Outputs—Refer FIGS. 13 and 14.
Technique/Logic—Rule-based logic.

In another embodiment, PLCs combine the function of the cloud-based charging management system and generates rolling demand forecast of EV charging load and EV data (e.g., EV Arrival time/departure time, SoC upon arrival or a statistical distribution of SoC upon arrival, SoC upon departure, required SOC upon departure or a statistical distribution of SoC upon arrival, customer identification, customer preferences and market prices for EV charging)—Refer FIGS. 7 & 8.

Rolling Unit Commitment

PLCs use charging demand data received from PLC/cloud-based charging management system and applies mathematical optimization techniques (linear/non-linear/mixed integer programming) to generate rolling unit commitment. This is then allocated to the different ILCs connected to it. This will set the upper bounds for the ILCs downstream for a time horizon of 6 or 12 hours. The rolling unit commitment is updated every hour based on the most recent results from rolling demand forecast. This continuous update of the rolling unit commitment model helps manage the large variability and stochasticity in EV charging demand.

Optimal Dispatch of DER (Optional Feature)

Aside from generating rolling unit commitment for ILCs, PLC also optimizes the operation of Distributed energy resources (DER)—e.g., solar PV and Battery energy storage. This optimization algorithm is based on mathematical optimization and/or rule-based logic providing set points to DERs. Objective function is to minimize total cost of operation (e.g., electricity cost) by optimizing the dispatch of DERs—Refer FIGS. 7 & 8.

In the case of mathematical optimization, PLC generates optimum set points using linear/non-linear/mixed integer programming.

Optimal dispatch of DERs is an optional feature since only some facilities will have onsite DERs

Algorithms for the Cloud-Based Charging Station Management System

Aside from the distributed control system described above, the solution also includes a cloud-based charging station management system. This is more of a management system providing functionalities like authentication of users, cost calculation for usage, billing of users, analytics, forecasting, machine learning, etc. It exchanges data with the plant level controller and provides user authentication and operation set points for the facility. Additionally, this also interfaces with utility systems for setting Time-of-Use (TOU) controls and participation in demand response programs etc. Refer FIGS. 7,8,9,10,11,12,13 and 14 for functionality, inputs, and outputs.

The cloud-based charging station management software is a multi-tenant software as a service platform. It is a standard information technology platform complete with databases, micro services, web based graphical interface, application program interfaces to other systems etc. hosted on cloud-based servers or on a platform like Amazon web services. The multi-tenant nature of the platform ensures sharing of database and application software across multiple users with clear separation of user data. Key functionalities of the cloud-based charging station management are master data management, user authentication, monitoring of usage, reporting, billing, demand forecasting and analytics. Most of these are standard functionalities available in many information technology platforms and hence are not elaborated here. However, one functionality needs special mention; that is, rolling demand forecast of EV charging load and its subset EV battery state of charge estimation. These are described below:

Rolling Demand Forecast of EV Charging Demand

In a preferred embodiment, the cloud-based charging management system generates rolling demand forecast of EV charging load and EV data (e.g., EV Arrival time/departure time, SoC upon arrival or a statistical distribution of SoC upon arrival, SoC upon departure, required SOC upon departure or a statistical distribution of SoC upon arrival, customer identification, customer preferences and market prices for EV charging). Algorithms used for this include statistical techniques (e.g., linear regression) and continuous machine learning (e.g., deep learning).

EV Battery State of Charge/kWh Estimation

Knowing battery state of charge (SOC) upon arrival and upon departure or kWh to be delivered to the EVs will improve the performance of the optimization. SOC data is used by the cloud-based charging station management system and/or PLC for generating rolling charging demand forecast and by CLCs for converting aggregate demand to charger level demand, rolling unit commitment and optimal dispatch. One could obtain SOC or kWh to be delivered as follows:
From the car through the EV charger. Some chargers provide this functionality.
From the car through the cloud-based service provided by automakers or service providers. Our API will get this data into the cloud-based charging station management system
Through statistical techniques and machine learning. We will have over time enough historical data to forecast the mobility behaviour of the specific driver and estimate the likely SOC/KWh upon arrival at the charging station and the required SOC upon departure or energy to be delivered.

Communication Methods and Protocols

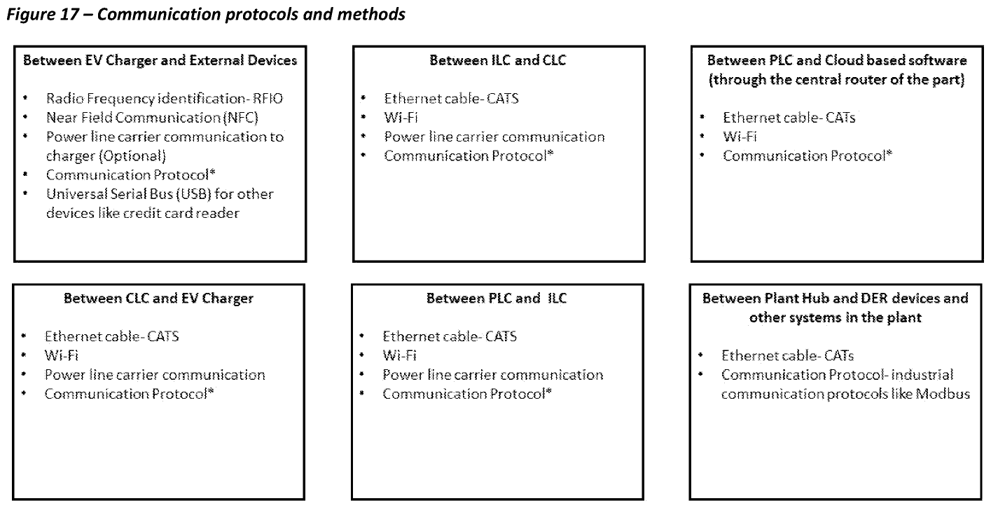

System is designed to support different types of communication methods including wired internet (CAT 5 cables), WiFi, power line carrier communication, cellular communication, Bluetooth, Zigbee etc—Refer FIG. 17.

User Interaction

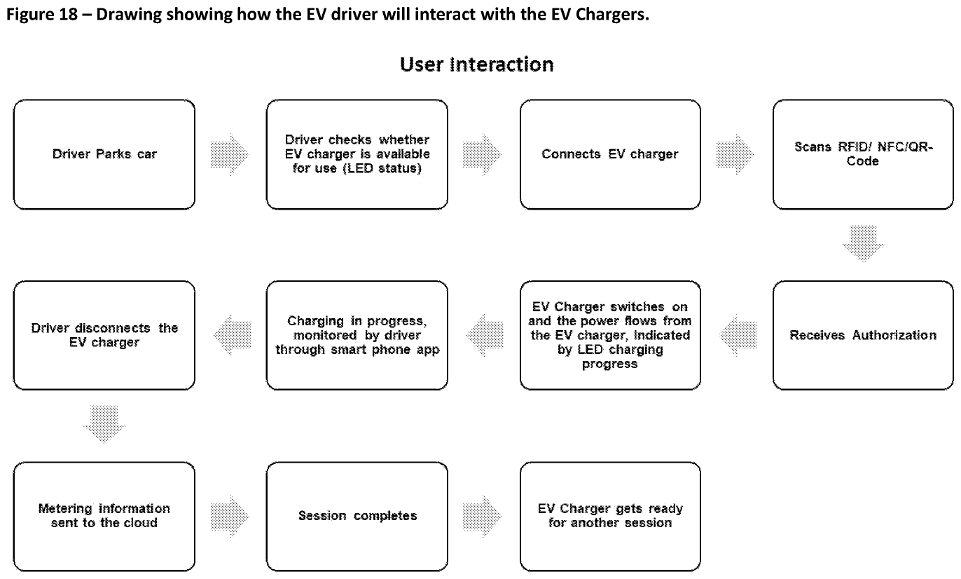

User interaction are with EV drivers for charging their EV and with facility mangers explain the interaction with all elements of distributed control system to cloud-based charging station management system. Refer FIG. 18.

Innovative Aspects of the Distributed Control System

The key innovation of the multilevel controller is its ability to mirror the hierarchal architecture of electrical power distribution network. This ensures that there is no overloading at any of the electrical circuits.

The modular nature allows for easy Plug and play design without need for altering configurations or making engineering changes during expansion when more EV are added in these facilities.

The optimization algorithms of CLCs, ILCs and PLCs will provide optimal dispatch every few seconds to few minutes following a Model Predictive Control paradigm. This will reoptimize the system based on real time values. Model predictive algorithms can provide much more benefits that the tradition rule-based logic.

Modular multi-level distributed control system architecture brings scalability with minimum exchange of information between controller units. Each controller unit collects data from EV chargers connected to one or more electrical circuits, aggregates it and transmits the aggregated data to the controller unit located immediately upstream. This aggregation of data at each controller unit is what brings scalability on the algorithmic level. Use of this aggregated data in optimization algorithms reduces the number of variables and complexity of the problem enabling use of low-cost hardware with less computing power and low bandwidth communication. Auto discovery feature makes this distributed control system truly plug and play.

### Definition of Select Terms

Network topology is the arrangement of the links (branches) and nodes (connection point) of a network. It uses graph theory to model nodes and connections between the devices of the network. We have two networks. One is the electric power flow network to the EV charger. The other is the controller network.

Network architecture refers to the design of the network. Network topology is just one part of the architecture. In the instant case we use topology and architecture interchangeably.

Electric power network consists of connected devices operating at specific voltage levels to deliver electric power. The supply side has a high voltage at one or more nodes node. This node branches to a set of lower-level nodes operating at a lower voltage on the load side.

Breakers or switches are present in all branches where the electric power flow need to be limited as power is delivered from the supply to the load. The devices in the power network are typically transformers, breakers and load equipment including chargers, sockets or charging points. The devices in the controller networks are computers, controllers, sensors, relays and related equipment to make controls effective in the power network.

The starting nodes in any electric power circuit are typically at the output of a transformer. The output of the transformer branches to various other lower nodes in the electric network. The branches are the wires that carry the electric power (usually indicated by solid line).

Meanwhile the nodes of the controller network are the controllers themselves and the branches are the communication lines between the controllers (usually indicated by dashed lines). The communication network can extend to include sensors and actuators to effectuate controller functions.

The network controllers in instant application are algorithmic and resident on low-cost hardware computers but not necessarily limited in any way and can have other hard and soft forms. They are physically close to the electric power network nodes. The communication in the controller network can be based on hard wire, Wi-Fi, Bluetooth, power line communication or any combination of these.

Nodal Topology of power networks typically is:

| | | |
|---|---|---|
| Utility Supply node | -------- | single node usually also called plant level or facility level; |

power comes in here from the utility; change of ownership of equipment at this point.

| | | |
|---|---|---|
| Intermediate nodes | ------ | single node or nodes at multiple levels -- a tree structure |
| Charger level node | ------- | single or multiple nodes ; usually one level. Also called circuit |

level node
------------------------------------------------------------------------------------------------------------------------

The utility and charger nodes are the interface nodes where the power network interfaces with the utility supply and the EV load respectively. Power typically flows from the utility node to the charger level node.

The different power network nodes are in a tree format topology where nodes can be upstream, downstream and in parallel in relation to any node.

Controller network topology Once again a tree format where each controller node sits next to a power network node. On the load sides the controller on the EV chargers itself are the nodes with nodal controllers upstream placed at every power network node.

Algorithmic controllers installed on low-cost hardware to be resident close to the node or physically near the node so as to maximize the level of edge computing that can take place. Edge computing will impact latency of the communication network.

Each Controller communicates with controllers above them and below it. Controllers at the same node levels do not communicate directly with each other.

Whenever we refer to EV Chargers, we also refer to Power Sockets, smart sockets or Connection Points. For the purpose of this invention they are synonymous. They are controllable and can be remotely turned on/off, and/or their charging rates/power flow varied. This control can be for unidirectional or bidirectional power/energy flow.

In the instant specification we have described some embodiments of our invention. This should not be considered limiting in any way or manner the broad range of configuration of many embodiments of the invention.

We claim:

1. A low-cost and scalable control system to optimize the electrical power flow in all branches of the electrical power distribution network supplying power to changing number of active EV chargers comprising
a) a network of distributed algorithmic controllers on low-cost hardware wherein each controller is at each node of the electrical power network to optimize the power flow for all output branches of the electrical distribution network supplying power to the EV chargers;
b) electrical power flow sensors for every branch of electrical power network;
c) software to implement optimization strategies with said algorithmic controllers;
d) a communication system that allows data exchange between algorithmic controllers, EV chargers and power flow sensors and wherein the controllers do not communicate with controllers at the same nodal level;
wherein the network of controllers optimizes the power flow in each upstream branch of the power network delivering power in response to the aggregate power demand set by a changing number of active EV chargers.

2. The control system of claim 1 wherein the controllers are modular and scalable.

3. The control system of claim 1 wherein the controllers are arranged in a hierarchical topology within the controller network.

4. The controllers of claim 3 wherein the hierarchy is based on node levels of the electrical power distribution network.

5. The control system of claim 1 wherein the topology of the controller network is the same as the network topology of the electrical power distribution network.

6. The control system of claim 1 used to optimize power flow in electrical power distribution networks with diverse loads besides EV chargers.

7. The control system of claim 3 where the controller and the power flow network have at least three hierarchical levels.

8. The control system of claim 7 wherein the three node levels are plant level, intermediate level, and circuit level.

9. The control system of claim 1 where in the controllers are physically close to the nodes they serve, thereby improving latency using edge computing techniques.

10. The control system of claim 2 where the algorithmic software optimizes the power flows in the branches of the electrical network delivering power to the EV chargers.

11. The optimization of claim 10 where controller algorithms use optimization strategies selected from the group comprising linear programming, non-linear programming, mixed integer programming, mixed integer programming or combinations thereof.

12. The control system of claim 2 wherein the electric power flow sensors can be based on current, power and/or voltage.

13. The power network of claim 1 where the electric power network designed to connect EV chargers to the grid is a new network, existing network, added network, retrofitted network, expanded network or a mix thereof.

14. The EV chargers of claim 1 can also be charging points or smart sockets.

15. A method to scale and cost-effectively add EV Chargers to any electric power network by:
a) defining the nodes and branches of the added electrical power network;
b) assembling a controller network of distributed algorithmic controllers with a controller at each node of the controller network to mirror the topology of the electrical power network;
c) establishing communication links for each controller with its adjacent hierarchically cascaded controllers in the controller network;
d) providing a power flow sensor at all branches emanating from each node for monitoring power flow;
e) optimizing electric power delivery to individual EV chargers using control algorithms to optimize electric power flow in each branch of the added electric power network based on varying aggregate power demand from the EV chargers;
f) optionally providing supervisory EV charging management software on a cloud platform that directly exchanges data with said controllers and EV chargers.
